(19) United States
(12) Patent Application Publication
(10) Pub. No.: US 2016/0324181 A1
(43) Pub. Date: Nov. 10, 2016

(54) TEMPERATURE RESISTANT CHOCOLATE COMPOSITION AND METHOD

(71) Applicant: The Hershey Company, Hershey, PA (US)

(72) Inventor: Steven James Hess, Lancaster, PA (US)

(21) Appl. No.: 15/216,000

(22) Filed: Jul. 21, 2016

Related U.S. Application Data
(62) Division of application No. 12/488,065, filed on Jun. 19, 2009.

(51) Int. Cl. A23G 1/40; A23G 1/48

(52) U.S. Cl. CPC A23G 1/40; A23G 1/48; A23V 2002/00

(57) ABSTRACT

A chocolate composition and a method for manufacturing the chocolate composition include a solid material, e.g., nutritive carbohydrate sweetener that has a particle size from about 50 to about 1000 nanometers. The solid material may comprise a sugar, such as but not limited to, sucrose. By including within the chocolate composition the solid material that has the particle size from about 50 to about 1000 nanometers, the chocolate composition has enhanced temperature resistance properties.

### BACKGROUND

1. Field of the Invention

The invention relates generally to chocolate compositions and methods for manufacturing chocolate compositions. More particularly, the invention relates to chocolate compositions with an enhanced temperature resistance and methods for manufacturing the chocolate compositions with the enhanced temperature resistance.

2. Description of the Related Art

Edible chocolates are common food products that may be included within other food products, such as, for example, baked goods (i.e., chocolate chips within chocolate chip cookies). Edible chocolates may also comprise food products that are consumed directly, absent additional food product processing, such as, for example, candy bars and other confectioneries.

Edible chocolates are categorized within the context of standards promulgated by the United States Food and Drug Administration under the Food, Drug and Cosmetic Act. They are also categorized within the context of standards promulgated by the Codex Alimentarius Committee on Cocoa Products of the Food and Agricultural Organization of the United Nations. Such categorization of edible chocolates may include, but is not necessarily limited to, edible dark chocolates, edible unsweetened chocolates, edible semi-sweet chocolates, edible sweet chocolates, edible milk chocolates, edible skim milk chocolates, white chocolates, and the like. Also included are alternative non-standard categorizations of edible chocolates.

Edible chocolates include as major components the products of processing cocoa beans in the form of chocolate liquor (i.e., chocolate liquor or cocoa mass, which is a solid or semi-solid substance that results from grinding of a cocoa bean nib) and cocoa butter (i.e. a material that results from further pressing of a cocoa bean from which the nib has been ground to form the chocolate liquor). Further processing of the pressed cocoa bean provides cocoa powder that has other food product uses.

As an example, chocolate liquor and cocoa butter may be mixed together with sugar to form sweet chocolate. Similarly, chocolate liquor and cocoa butter may be mixed together with sugar and milk solids to form milk chocolate. Particular compositions of other edible chocolate compositions are also known.

The most popular edible chocolate or candy consumed in the United States is in the form of sweet chocolate or milk chocolate. Milk chocolate is a confection which contains non-fat milk solids, milkfat, chocolate liquor, a nutritive carbohydrate sweetener, cocoa butter and may include other optional ingredients such as emulsifiers and flavorings and other additives. Sweet chocolate differs from milk chocolate in that it requires more chocolate liquor and limits the amount of milk solids.

Semisweet chocolate requires at least 35 percent by weight chocolate liquor and is otherwise similar in definition to sweet chocolate. Commonly known dark chocolate, generally containing only chocolate liquor, a nutritive carbohydrate sweetener, and cocoa butter, is by definition either a sweet chocolate or a semisweet chocolate.

White chocolate differs from milk chocolate in that it contains no non-fat cocoa solids.

As used herein, the term “chocolate” denotes a type of chocolate, for example, milk chocolate, sweet chocolate, semisweet chocolate, buttermilk chocolate, skim milk chocolate, mixed dairy product chocolate, white chocolate, compound chocolate, (chocolate in which all or part of the cocoa butter is replaced by vegetable fat, e.g., hard vegetable fat tropical fat, such as coconut oil, palm kernel oil, shea oil, and the like) and non-standardized chocolate, unless specifically identified otherwise.

As a confection, chocolate can take the form of solid pieces of chocolate, such as bars or novelty shapes, and can also be incorporated as a component of other, more complex confections, for example, as where chocolate is combined with and generally coats other foods, such as caramel, nougat, fruit pieces, nuts, wafers or the like. These foods are characterized as microbiologically shelf-stable at 65 to 85° F. under normal atmospheric conditions. Other complex confections result from surrounding soft inclusions such as cordial cherries or peanut butter with chocolate. Still other complex confections result from coating ice cream or other frozen or refrigerated desserts with chocolate. Generally chocolate used to coat or surround foods must be more fluid than chocolates used for plain chocolate solid bars or novelty shapes.

The process of coating chocolate onto a food is known as enrobing. Enrobing is accomplished when the chocolate is in a fluid state and coats a food. Proper viscosity must be maintained in order to produce a satisfactory coated product.

Chocolate can also be molded. By molding, it is meant that chocolate, either plain or mixed with nuts, raisins, crisped rice and the like is deposited in molds, allowed to cool, hardened into solid pieces, and then removed from the molds. Chocolate molded into plain chocolate pieces generally can be somewhat more viscous than coating chocolates since the chocolate can be deposited into a mold and vibrated over a longer period of time than in enrobing. However, chocolate molded with food inclusions generally must be as fluid as coating chocolates.

Some novelty shapes made of plain chocolate are extruded onto a cold belt such as Kisses® Chocolate or chocolate chips. Because the chocolate is extruded onto a cold belt, it must be more viscous than molded plain chocolate. Extruded chocolates are essentially extruded to a particular shape and require a yield value to retain the extruded shape while the chocolate hardens.

Common to edible chocolates is a tendency to melt at a temperature at about body temperature. While such a melting temperature often provides no difficulties in stability of an edible chocolate, nonetheless in tropical climates, and also when contacted with a human body at body temperature, edible chocolates have an undesirable tendency to melt.

Thus, desirable are edible chocolates that are temperature resistant (i.e., dimensionally stable at a temperature greater than about 35° C.), and methods for manufacturing the chocolates that are temperature resistant.

### SUMMARY

The present invention includes a chocolate composition and a method for manufacturing the chocolate composition. The chocolate composition, in accordance with the present invention, is temperature resistant insofar as the chocolate composition remains dimensionally stable at a temperature greater than about 35° C. Such a temperature resistant chocolate composition is desirable since such a temperature resistant chocolate composition is resistant to melting in tropical climates, or when contacted by a human body at body temperature.

The temperature resistant chocolate composition, in accordance with the present invention, includes a solid material (e.g., typically a nutritive carbohydrate sweetener such as but not limited to, sucrose) which contains at least about 1% by weight of the chocolate composition having a particle size ranging from about 50 to about 1,000 nanometers. Typically, the nanosized material comprises a portion of the total amount of the solid material, e.g., nutritive carbohydrate sweetener, present in the chocolate composition. In an embodiment, it is present in an amount ranging from about 2 to about 80 wt % of the total amount of nutritive carbohydrate sweetener in the chocolate composition of the present invention.

In an embodiment, the aforementioned nanoparticles are present within the temperature resistant chocolate composition at a weight percentage ranging from about 1 to about 40 weight percent. The remaining solid material i.e., carbohydrate nutritive sweetener, such as sucrose, is present in the chocolate composition in the normal particle size range, e.g., from about one micrometer up to and including about 100 micrometers, and this is present in an amount ranging from about 15 wt % to about 45 wt % of the temperature resistant chocolate composition of the present invention and in another embodiment from about 25 wt % to about 40 wt % of the chocolate composition.

A particular method for manufacturing a chocolate composition in accordance with the present invention includes mixing together a solid material, such as a nutritive carbohydrate sweetener, that has a particle size from about 50 to about 1,000 nanometers with cocoa butter, and an emulsifier and nutritive carbohydrate sweetener present in its normal size. Optionally other ingredients may be present, such as those ingredients normally found in chocolate e.g., non-fat dairy solids, non-fat cocoa solids, milkfat and the like, in amounts sufficient to maintain a chocolate paste and for a time sufficient to thoroughly mix these components, and then tempering the resulting chocolate.

### BRIEF DESCRIPTION OF THE DRAWINGS

The objects, features, and advantages of the invention are understood within the context of the Description of the Preferred Embodiment, as set forth below. The Description of the Preferred Embodiment is understood within the context of the accompanying drawings, that form a material part of this disclosure, wherein

FIG. 1 shows a schematic diagram of a process used for manufacturing a chocolate composition in accordance with the present invention.

FIG. 2 is a graph that compares the of Viscosity versus Shear Rate for chocolate compositions manufactured in accordance with the present invention relative to regular chocolate. In FIG. 2, the line _ represents the composition containing 0% nanoparticles, the symbol ∇ represents the composition containing 4.5% (w/w) nanoparticles and the symbol ⋄ represents the composition containing 9% (w/w) nanoparticles.

FIG. 3 shows a graph of Probe Position versus Temperature for chocolate compositions manufactured in accordance with the present invention. In FIG. 3, the line _ represents the composition containing 0% nanoparticles, the symbol ∇ represents the composition containing 4.5% (w/w) nanoparticles and the symbol ⋄ represents the composition containing 9% (w/w) nanoparticles.

FIG. 4 shows a graph of Probe Position versus Dynamic Force for chocolate compositions prepared as described in Example 1. The legend is the same as in FIG. 2.

FIG. 5 shows a graph of DMA (Dynamic Mechanical Analyzer) Probe Position versus Temperature for dark chocolate compositions prepared as described in Example 2 incorporating 0% and 9% (w/w) nanosized sucrose, respectively. The composition containing 0% nanoparticles is depicted as the symbol ⋄ and the composition containing 9% (w/w) nanoparticles is depicted as the line _.

FIG. 6 shows graphically DMA (Dynamic Mechanical Analyzer) Probe Position versus temperature for milk chocolate prepared as described in Example 3, incorporating 0% and 9% (w/w) nanosized sucrose, respectively. The composition containing 0% nanoparticles is depicted as the symbol ⋄ and the composition containing 9% (w/w) nanoparticles is depicted as the line _.

FIG. 7 shows a graph of DMA (Dynamic Mechanical Analyzer) Probe Position versus Temperature for compound chocolate prepared in accordance with Example 4 incorporating 0 and 9% nanosized sucrose, respectively. The composition containing 0% nanoparticles is depicted as the symbol ⋄ and the composition containing 9% (w/w) nanoparticles is depicted as the line _.

### DETAILED DESCRIPTION OF THE INVENTION

The present invention, which includes a temperature resistant chocolate composition and a method for manufacturing the temperature resistant chocolate composition, is understood within the context of the description set forth below. The description set forth below is understood within the context of the drawings described above. Since the drawings are intended for illustrative purposes, the drawings are not necessarily drawn to scale.

As described above, in an embodiment, the present invention is directed to a heat resistant chocolate containing the ingredients normally found in chocolate, except that the size of some of the solid particles thereof, e.g., are in the nanometer range.

In the present invention, some of the nutritive carbohydrate sweeteners are in the nanometer size range; other types of ingredients, as described hereinbelow may also be in the nanometer size.

As used herein, the term “nutritive carbohydrate sweetener” refers to a sweetener that is typically used in the confectionery arts. Examples include, but are not limited to, sucrose, (e.g., from cane or beet), dextrose, fructose, lactose, maltose, glucose syrup solids, corn syrup solids, invert sugar, hydrolyzed lactose, honey, maple sugar, brown sugar, molasses and the like. The nutritive carbohydrate sweetener will be present in the chocolate composition as crystals or particles. The nutritive carbohydrate sweetener in one embodiment is sucrose.

The present invention includes a temperature resistant chocolate composition and a method for manufacturing the temperature resistant chocolate composition. Both the temperature resistant chocolate composition and the method for manufacturing the temperature resistant chocolate composition include a solid material, such as but not limited to a sweetener, and more particularly to a nutritive carbohydrate sweetener, such as but not limited to sucrose, that has a particle size from about 50 to about 1,000 nanometers, and in another embodiment, from about 75 to about 500 nanometers, and in still another embodiment, from about 100 to about 300 nanometers and in still another embodiment at about 200 nanometers. The foregoing solid material with the above designated particle size is present within the temperature resistant chocolate composition at a weight percentage from about 1 to about 40 weight percent, in another embodiment, from about 3 to about 20 weight percent and in still another embodiment from about 5 to about 10 weight percent and in still another embodiment, from about 4 wt % to 9 wt % of the total composition.

As described herein, a component of the present composition is the nutritive carbohydrate sweetener. The present composition contains one or more nutritive carbohydrate sweeteners, as defined herein, having particles in the nanometer range. The amount utilized in the nanometer size is that amount that allows the chocolate composition to exist as a solid at body temperature or above, i.e., it does not melt at body temperature or below. The nutritive carbohydrate sweetener having particles in the nanometer size is but a fraction of the total amount of nutritive carbohydrate sweetener present in the chocolate composition of the present invention. In an embodiment, the amount of nutritive carbohydrate sweetener present having nanosized particles ranges from about 2 to about 80 wt % of the total amount of nutritive carbohydrate sweetener present in the composition, and in another embodiment, it ranges from about 6 to about 40 wt % of the total amount of nutritive carbohydrate sweetener present in the composition and in still another embodiment, from about 10% to about 20% of the total amount of nutritive carbohydrate sweetener present in the composition. One or a mixture of more than one nutritive carbohydrate sweetener may be present having particle sizes in the nanometer range referred to hereinabove. As used herein, the terms “nanosized nutritive carbohydrate sweetener” and “particles of the nutritive carbohydrate sweetener in the nanometer range” are synonymous and refer to the particles of the nutritive carbohydrate sweetener that are in the nanometer range defined hereinabove.

However, the present invention contemplates, in another embodiment, that other components of the chocolate composition can also be optionally present with particle sizes in the nanometer ranges described hereinabove. For example, besides the nutritive carbohydrate sweetener, a portion of the non-fat cocoa solids or non-fat dairy solids, if present (and depending upon the type of chocolate) may be reduced to the nanometer range.

In an embodiment, the non-fat cocoa solids, if present, optionally has particles present in the nanometer range in an amount ranging from about 3 wt % to about 40 wt % of the chocolate composition, while in another embodiment, the non-fat cocoa solids, if present, are in the nanometer range in an amount ranging from about 4 wt % to about 20 wt % of the chocolate composition, and in still another embodiment, the non-fat cocoa solids, if present, have particles present in the nanometer range in an amount ranging from about 5 wt % to about 10 wt % of the chocolate composition. Again, as with the nutritive sweetener, the amount of non-fat cocoa solids present in the nanometer range is only a fraction of the total amount of the non-fat cocoa solids present. In one embodiment, even if present, the composition contains no non-fat cocoa solids in the nanometer range. In another embodiment, nanosized non-fat cocoa solids are present in an amount ranging from about 1 to about 80 wt % of the total amount of non-fat cocoa solids and in another embodiment, it is present in an amount ranging from about 5 to about 50 wt % of the total amount of non-fat cocoa solids, in another embodiment from about 10 to about 30 wt % of the total amount of cocoa solids present.

In an embodiment, the aforementioned nanometered particles of non-fat solids range from about 50 nanometers to about 1,000 nanometers, and in another embodiment, from about 75 to about 500 nanometers and in another embodiment from about 100 to about 300 nanometers and in another embodiment, they are about 200 nanometers. In an embodiment, the diameter of the nanosized particles of the non-fat cocoa solids is about equal to the diameter of the nanosized nutritive carbohydrate sweetener particles. As used herein, the terms “nanosized non-fat cocoa solids” and “cocoa solids having nanosized particles” are synonymous and refer to particles of non-fat cocoa solids in the aforementioned nanometer ranges.

If the chocolate composition contains non-fat dairy solids, including non-fat milk solids (hereinafter “non-fat dairy solids”), some of the non-fat dairy solids may optionally be nanosized. In an embodiment, even if non-fat dairy solids are present in the chocolate composition, none of the non-fat dairy solids are present in the nanometer range. In another embodiment, the amount of nanosized non-fat dairy solids present ranges from about 1 to about 25% by weight of the chocolate composition. In another embodiment these non-fat dairy solids present in the nanometer size ranges from about 2 wt % to about 20 wt % of the composition. In another embodiment, the amount of non-fat dairy solids present in the nanometer size ranges from about 5 wt % to about 15 wt % of the composition. In an embodiment, the aforementioned particles of non-fat dairy solids, if present, in the nanometer size range in size from about 50 nanometers to about 1,000 nanometers and in another embodiment from about 75 to about 500 nanometers, and in another embodiment from about 100 to about 300 nanometers and in another embodiment, they are about 200 nanometers. In an embodiment, the diameter of the nanosized particles of the non-fat dairy solids present in the heat-resistant chocolate is about equal to the diameter of the nanosized nutritive carbohydrate sweetener particles.

Again, the amount of the non-fat dairy solids present in the nanometer range is a fraction of the total amount of non-fat dairy solid present. In an embodiment, as indicated hereinabove, none of the non-fat dairy solids are nanosized. In another embodiment, the amount of nanosized non-fat dairy solids is present in an amount ranging from about 1 to about 90 wt % of the total amount of non-fat dairy solids present, and in another embodiment, from about 3 to about 60 wt % of the total amount of non-fat dairy solids present and in another embodiment from about 5 to about 50 wt % of the total amount of milk solids present.

As used herein, when referring to particle sizes, it is to be understood that it refers to the median particle size. Furthermore, in one embodiment, the particles of nanometer dimension are spherical so that the particle sizes referred to herein relate to the diameter of the particle. However, in other instances, the particle size is expressed as a spherical equivalent, that is, they are not necessarily spherical, but the size is expressed as if they were spherical in shape. Moreover, unless indicated to the contrary, particle sizes are expressed as the diameter of the spherical particles.

Particle sizes can be measured by various techniques known to those skilled in the art. These techniques include the laser light scattering, measurements using a micrometer and measurement using a microscope and the like. Unless otherwise specified herein, when referring to the particle size of the nutritive carbohydrate sweetener, the measurements were taken using the laser light scattering technique.

As described herein, there is a limit to the amount of particles in the heat resistant chocolate of the present invention that are in the nanometer size range. As to a lower limit, the composition of the chocolate composition contains sufficient amount of the particles in the nanometer range so that the melting point of the chocolate composition of the present invention is above the melting point of typical chocolate, i.e., above body temperature. In an embodiment, the melting point of the chocolate composition of the present invention is at least about 5° C. above the melting point of regular chocolate.

On the other hand, there is also a maximum amount of nanosized particles present in the chocolate composition of the present invention, for, as the amount of nanosized particles increases, there is an effect on the rheological properties, e.g., the viscosity of the chocolate composition becomes more viscous. Thus, the upper limit is that amount sufficient to maintain the rheological properties, including viscosity, of the chocolate composition of the present invention in a range suitable for further processing, e.g., molding, extruding or enrobing. Moreover, the diameter of the nanoparticles is as described hereinabove, i.e., from about 50 nm to about 1000 nm. Thus, the chocolate composition of the present invention has the rheological properties, including viscosity, in the range that is present in standardized chocolate. In an embodiment, the viscosity of the chocolate composition ranges from about 10 to about 2000 Pa·s at 40° C. over a range of shear rates, such as from about 0.01 to about 100 sec-1. In an embodiment, the other physical characteristics of the composition of the present invention are about the same as that of typical chocolate.

In the present invention, some of the nutritive carbohydrate sweeteners are in the nanosized range, as defined herein; other types of ingredients, as described below, may also be in the nanometer range. In an embodiment, a portion of the nutritive carbohydrate sweetener and optionally a portion of either the non-fat cocoa solids and the milk solids or both are in the nanosized range, as defined herein. In an embodiment, from about 1 to about 50 wt % of the solids present are in the nanometer size range and, in another embodiment, from about 3 to about 30 wt % are in the nanometer size range and in another embodiment, from about 5 to about 20 wt % of the solids in the chocolate composition are in the nanometer size range.

The chocolate composition of the present invention contains those ingredients normally found in chocolate, but as identified hereinabove, some of them are in the nanometer size range. Thus, an embodiment of the present invention is directed to a chocolate composition wherein a portion of the nutritive carbohydrate sweetener is in the nanometer range, said chocolate composition maintaining shape at temperature above that of normal chocolate, that is, above body temperature, while still maintaining the rheological properties of the liquid chocolate in a range suitable for further processing, e.g., molding, extruding or enrobing.

The chocolate composition of the present invention contains, in normal size, various ingredients normally found in chocolate, for example, cocoa butter and/or chocolate liquor, nutritive carbohydrate sweetener, and optionally emulsifiers. Depending on the type of chocolate, other ingredients maybe present, such as milkfat, non-fat cocoa solids, non-fat dairy solids, e.g., non-fat milk solids, and the like. The present invention contemplates nanosized particles, described above, present in various types of chocolates, such as standardized semisweet chocolate, standardized sweetened chocolate, and standardized milk chocolate, standardized white chocolate and the like. The various ingredients present in the various types of standardized chocolate are contemplated within the present invention, with the total amount of each of these ingredients, including those found in the nanosized range, being within the range normally found in the corresponding standardized chocolate composition. For example, even though some of the nutritive carbohydrate sweetener particles of the present invention may be in the nanometer size, the total amount of nutritive carbohydrate sweetener in the present invention is within the range normally found in chocolate. For example, if the chocolate composition is milk chocolate, the total amount of nutritive carbohydrate sweetener in the present invention, i.e., nanosized as well as normal sized particles thereof, are within the range normally found in standardized milk chocolate.

Thus, the chocolate composition of the present invention contains the total amount of cocoa butter and/or chocolate liquor, nutritive carbohydrate sweetener, non-fat dairy (e.g., milk) solids, if present, emulsifiers, if present, non-fat cocoa solids, if present, typically found in chocolate.

As indicated above, the composition of the present invention contains cocoa butter and/or chocolate liquor which contains cocoa butter, wherein the particles are of the size that are normally found in standardized chocolate.

A chocolate composition in accordance with this embodiment may include other ingredients and additives that are otherwise generally conventional in the chocolate manufacturing art and these other ingredients and additives are the same size that are normally found in standardized chocolate.

The chocolates of the instant embodiment may additionally contain optional ingredients wherein the size of the particles found therein is in the normal range. These optional ingredients include emulsifiers, non-fat milk solids, non-fat cocoa solids, sugar substitutes, natural and artificial flavors (e.g., vanillin, spices, coffee, ethyl vanillin, salt, brown nut-meats; natural vanilla, etc., as well as mixtures of these), antioxidants (e.g., preservatives such as TBHQ, tocopherols and the like), proteins, and the like.

The present invention contemplates that sugar substitutes, e.g., sugar alcohol or bulking agents or high potency sweeteners, may replace all or a fraction of the nutritive carbohydrate sweeteners used in the present application. Although these may replace a portion of the nutritive carbohydrate sweeteners in the nanometer size, in an embodiment, these replace partially or fully the nutritive carbohydrate sweeteners present in the size normally found in chocolates. Except for the nanosized particles, the particle size ranges from about 1 to about 100 micrometer, and the median size particles range from about 10 to about 30 micrometers. However, in another embodiment, a portion of the sugar substitute, e.g., sugar alcohol or bulking agent may be present in the nanometer size. In an embodiment, the sugar substitute, e.g., the sugar alcohol, bulking agent and/or high potency sweetener, in its entirety or a portion thereof, may be present in the nanometer range and if present in the nanometer range, they may be present in an embodiment from about 50 to about 1000 nm., in another embodiment from about 75 to about 500 nm., and in another embodiment from about 100 to about 300 nm and in another embodiment at about 200 nm. For example, in an embodiment, the bulking agent has particles in the range of from about 50 to about 1000 nm. In another embodiment, the bulking agent has particles in the range from about 75 to about 500 nm. In another embodiment, the bulking agent has particles in the range from about 100 to about 300 nm. In still another embodiment, the bulking agent has particles in size of about 200 nm.

As used herein, the term “sugar substitute” includes bulking agents, sugar alcohols (polyols), or high potency sweeteners or combinations thereof.

Particular examples of sugar alcohols may be any of those typically used in the art and include sorbitol, mannitol, xylitol, maltitol, isomalt, lactitol, erythritol, and the like.

Particular bulking agents as defined herein may be any of those typically used in the art and include polydextrose, cellulose and its derivatives, maltodextrin, gum arabic, and the like.

Particular high potency sweeteners include aspartame, cyclamates, saccharin, acesulfame, neohesperidin dihydrochalcone, sucralose, alitame, stevia sweeteners, glycyrrhizin, thaumatin and the like and mixtures thereof. The preferred high potency sweeteners are aspartame, cyclamates, saccharin, acesulfame-K, and sucralose.

However, the above sugar substitutes, e.g., sugar alcohol, bulking agents and high potency sweeteners are present in the amounts normally found in standardized chocolate products.

The chocolates of the instant embodiment may contain a trace of water. It is preferred that they contain less than 1% moisture by weight, preferably less than 0.75% moisture by weight, in order to meet the flow requirements. Higher moisture is very detrimental to the Casson yield value and plastic viscosity and would otherwise require substantial additional fat to counteract its negative effect on rheology.

The chocolate compositions of the present embodiment may contain emulsifiers. Examples of safe and suitable emulsifiers may be any of those typically used in the art and include lecithin derived from vegetable sources such as soybean, safflower, corn, and the like, fractionated lecithins enriched in either phosphatidyl choline or phosphatidyl ethanolamine or both, mono- and diglycerides, diacetyl tartaric acid esters of mono- and diglycerides (also referred to as DATEM), monosodium phosphate derivatives of mono- and diglycerides of edible fats or oils, sorbitan monostearate, polyoxyethylene sorbitan monostearate, hydroxylated lecithin, lactylated fatty acid esters of glycerol and propylene glycol, polyglycerol esters of fatty acids, propylene glycol mono- and diester of fats and fatty acids or any emulsifier that may become approved for the USFDA-defined soft candy category. In addition, other emulsifiers that can be used in the present invention include polyglycerol polyricinoleate (PGPR), ammonium salts of phosphatidic acid, sucrose esters, oat extract, etc., any emulsifier found to be suitable in chocolate or similar fat/solid system or any blend provided the total amount of emulsifier does not exceed 1% by weight. Emulsifiers preferred for use in the present invention are lecithin, fractionated lecithin, diacetyl tartaric acid esters of mono- and diglycerides (DATEM), PGPR or mixtures of these emulsifiers at a maximum level of 1% of any one emulsifier or any mixture of emulsifiers. Especially preferred is lecithin, PGPR, or mixture thereof.

Thus, it is to be understood that the chocolate composition of the present invention contains the components normally found in chocolates and the size of particles thereof are of the size normally found in chocolates. For example, it contains the nutritive carbohydrate sweetener, the cocoa butter and/or chocolate liquor and emulsifiers normally found in chocolates and the particles sizes of these are those that are typically found in chocolates. Any of the nutritive carbohydrate sweeteners and emulsifiers, for example, typically found in chocolates is present in the chocolate composition of the present invention. Nevertheless, in an embodiment, the nutritive carbohydrate sweetener that is present in the nanometer range, as defined hereinabove, is also present as a component of the chocolate composition in a size normally found in chocolates. For example, if the chocolate composition contains sucrose in a nanometer size, the chocolate composition also contains sucrose as an additional component in the normal size typically found in chocolates.

The present invention contemplates that a portion of the nutritive carbohydrate sweetener, as defined herein, and optionally non-fat cocoa solids and optionally non-fat dairy solids will be in the nanometer range and, together with chocolate liquor and/or cocoa butter and with the other ingredients normally found in chocolate, provides several types of chocolate compositions. Such chocolate compositions may include, but are not necessarily limited to dark chocolate, semi-sweet chocolate, sweet chocolate, milk chocolate, buttermilk chocolate, as well as any of several varieties of non-standard chocolates.

In accordance with the present invention, various chocolate compositions may be prepared. For example, the present invention contemplates an improved milk chocolate composition which contains cocoa butter, chocolate liquor, non-fat milk solids, non-fat cocoa solids, whole milk powder, a nutritive carbohydrate sweetener, such as sucrose, and a trace amount of water. The chocolate composition of the present invention contains a fraction of the nutritive carbohydrate sweetener or other sugar substitute, present in the nanometer range, as described above. In one embodiment, the only particles in the nanometer range are the nutritive carbohydrate sweetener. In another embodiment, the present invention is directed to an improved milk chocolate composition, wherein the improvement comprises both a fraction of the nutritive carbohydrate sweetener and a fraction either of the non-fat dairy solids (e.g., non-fat milk solids) or non-fat cocoa solids or both being in the nanometer range described hereinabove, with the fraction thereof being within the range defined above.

This milk chocolate composition, which has desirable flow properties, contains from about 20% to about 35% total fat, and preferably contains less than about 7% milkfat, less than about 1% moisture, preferably below 0.75% wt., and 35% minimum, preferably over 40% nutritive carbohydrate sweetener with specific limitations on the sweetener particle size, as defined hereinabove of the nutritive carbohydrate sweetener, from about 2 to about 80 wt % of the total amount of the nutritive carbohydrate sweetener are nanosized, other embodiments have the nanosized particles of the nutritive carbohydrate sweeteners in the ranges described hereinabove. Because of this unique composition, the chocolate of the present invention meets flow requirements for both molding and enrobing.

For example, standardized milk chocolate in accordance with the present invention must also, in addition to the requirements already given for the total fat, milkfat, moisture, rheology, and nutritive carbohydrate sweetener, contain a minimum of 8.61% milk solids non-fat and 10% chocolate liquor, a range of 3.39-7.00% milkfat and greater than 35% by weight nutritive carbohydrate sweetener. However, a fraction thereof and optionally some of the milk solids as defined above, have particles in the nanometer range. Another embodiment has 12-20% milk solids-non-fat, 3.39-5.00% milkfat, 12-15% chocolate liquor, and 0.5% maximum emulsifier and greater than 40% nutritive carbohydrate sweetener with a fraction thereof and optionally the milk solids, as defined above, having these particles in the nanometer range. Cocoa butter may be added as needed to reach the desired total fat content. The proportion of milkfat to cocoa butter is important so that the desired degree of hardness is achieved in the chocolate. The milkfat component can be delivered by anhydrous milkfat (AMF), cream, butter, whole milk powder, or any mixture thereof.

The present invention contemplates a skim milk chocolate composition. The skim milk chocolate can be formulated by keeping the milkfat component under 3.39%, preferably under 1%, and raising the minimum milk solids non-fat component to 12%.

In accordance with the present invention, another embodiment is directed to an improved standardized skim milk chocolate composition wherein the improvement comprises a fraction of the nutritive carbohydrate sweetener (e.g. sucrose); in the range described hereinabove this fraction having nanosized particles in the nanometer range with the size as defined hereinabove. In another embodiment, the chocolate composition is an improved standardized skim milk chocolate with the improvement comprising a fraction of the nutritive carbohydrate sweetener and either non-fat dairy solids, e.g., non-fat milk solids or non-fat cocoa solids or both the non-fat dairy solids and the non-fat cocoa solids, being in the nanometer range as defined hereinabove in the nanosizes defined hereinabove. The skim milk chocolate contains the same ingredients as milk chocolate, but the non-fat milk solid in fact is present in greater amounts, for example, 12-20% non-fat milk solids. However, in the various embodiments, it contains the same other ingredients as milk chocolate.

The present application encompasses a buttermilk chocolate composition. The ingredients of the standardized buttermilk chocolate compositions are the same as defined for milk chocolate, except that it contains dried sweet cream buttermilk in an amount of about 12% to about 20 wt % by weight and the milkfat is from cream butter or from dried sweet cream buttermilk and this is present in an amount of less than about 3.3% by weight of the composition. In the various embodiments contemplated, it contains the other ingredients in the same amounts as present in milk chocolate.

In another embodiment, the present invention is directed to an improved standardized buttermilk chocolate composition, wherein the improvement comprises a fraction of the total nutritive carbohydrate sweetener in the nanometer range defined hereinabove, wherein the size of this component is in the nanometer size described hereinabove. In another embodiment, the present invention is directed to an improved standardized buttermilk composition wherein a fraction of the nutritive carbohydrate sweetener and the non-fat dairy solids or the non-fat cocoa solids or both the non-fat dairy solids and the non-fat cocoa solids are nanosized, as described hereinabove with the amount of the nanosized particles being within the range described hereinabove.

Another type of chocolate contemplated in the present invention is a mixed dairy product chocolate. Mixed dairy product chocolates are identical to milk chocolate; as defined above, except that the milkfat component may be below 3.39%. It is preferred that the milkfat component is 0 to 7%, and more preferably 0 to 5.5%. Mixed dairy product chocolates allow a wider choice as to the type of milk solids non-fat component. The other ingredients present are the same as those in milk chocolate and they are present in the same amounts as milk chocolates.

In another embodiment, the present invention is directed to an improved standardized mixed dairy chocolate composition, wherein the improvement comprises the fraction of the total nutritive carbohydrate sweetener, e.g., sucrose, in the nanometer range, described hereinabove, wherein the size of the component in the nanometer size is as described hereinabove. In another embodiment, the present invention is directed to an improved standardized dairy chocolate composition wherein a fraction of nutritive carbohydrate sweetener and either the non-fat dairy (milk) solids or the non-fat cocoa solids or both non-fat dairy solids and the non-fat cocoa solids are in the nanometer size described hereinabove and both have nanometered size particles within the range described hereinabove.

The present invention in still another embodiment, contemplates an improved standardized sweet chocolate composition. Sweet chocolates are identical to milk chocolates, except that the chocolate liquor content is usually 15-35% and the total milk solids may not exceed 12%. For this embodiment, the milkfat component preferably ranges from 0 to 7%, and more preferably from 0 to 3.5%. Semi-sweet chocolate (or bittersweet chocolate) is similar to sweet chocolate except that the chocolate liquor content exceeds 35%.

In still another embodiment, the present invention is directed to an improved standardized sweet chocolate composition, wherein the improvement comprises the fraction of the total nutritive carbohydrate sweetener, e.g., sucrose, in the nanometer range, wherein the size of this component that is nanosized is in the range described hereinabove. In another embodiment, the present invention is directed to an improved standardized sweet composition wherein a fraction of the nutritive carbohydrate sweetener and either the nonfat cocoa solids, non-fat dairy solids, or both the non-fat dairy products and non-fat cocoa solids are in the nanometer size described hereinabove and the size of the nanometer particles are within the ranges described hereinabove.

In another embodiment, the present invention is directed to an improved standardized semi sweet chocolate composition, wherein the improvement comprises the fraction of the total nutritive carbohydrate sweetener, e.g., sucrose, in the nanometer range, wherein the amount of said component in the nanometer size is in the range described hereinabove and the sizes being in the range described hereinabove. In another embodiment, the present invention is directed to an improved standardized semi sweet chocolate composition wherein a fraction of nutritive carbohydrate sweetener and either the non-fat dairy solids or non-fat cocoa solids or both are present as nanosized particles as defined hereinabove, with the size of the nanosized particles being in the range described hereinabove.

In another embodiment, the chocolate composition is a white chocolate. A white chocolate of this embodiment would preferably contain from about 28% to about 35% total fat consisting of 3.5-4.5% milkfat and 23.5-31.5% cocoa butter, 35-55% nutritive carbohydrate sweetener, preferably 40-55%, 10.5% minimum milk solids non-fat, preferably 12-25%, and 0% chocolate liquor.

In an embodiment, the present invention is directed to an improved standardized white chocolate composition, wherein the improvement comprises the fraction of the total nutritive carbohydrate sweetener, e.g., sucrose, having particles in the nanometer size, as defined above, wherein the amount of said component in the nanometer size in the range described hereinabove. In another embodiment, the present invention is directed to an improved standardized white chocolate composition wherein a fraction of the nutritive carbohydrate sweetener have particles in the nanometer size, in accordance with the description above and the size of the particles in the nanometer range is within the ranges described hereinabove. In another embodiment, the present invention is directed to an improved white chocolate wherein a fraction of the nutritive carbohydrate sweetener and the non-fat dairy solids have particles in the nanometer size as defined hereinabove, and the fraction of the nutritive carbohydrate sweetener and the non-fat dairy solids that are in the nanometer size are as defined hereinabove.

Non-standardized chocolates are also contemplated herein. They may contain sugar substitutes. Vegetable fats other than cocoa butter may replace some or all of the cocoa butter to prepare a chocolate flavored confectionery. Independent on the type of nonstandardized chocolates, such as non-standardized milk chocolate, non-standardized buttermilk chocolate, non-standardized skim milk chocolate, non-standardized mixed dairy product chocolate, non-standardized sweet chocolate, non-standardized white chocolate and the like, in an embodiment, a fraction of the nutritive carbohydrate sweetener present is in the range described hereinabove, with the size of the nanometer particles being in the range defined hereinabove, and optionally the milk solids and/or non-fat cocoa solids have a fraction of the total being in the nanometer range, as described hereinabove and the size of these nanosized particles being in the range described hereinabove. Non-standardized chocolates may also contain cocoa powders as partial or total substitutes for chocolate liquor. In a preferred embodiment, coarsely ground cocoa powder replaces over 50% of the total cocoa solids and is prepared by grinding or pulverizing a cocoa presscake so that less than 75% will pass through a U.S. standard screen #200 and less than 50% through a #400 screen. (Commercially available cocoa powders typically are ground in high impact mills such that 98%+ pass through a #200 screen and 90%+through a #400 screen.). This coarsely ground cocoa powder can be fed into the nip of a roll refiner and final particle size reduction is accomplished by the rolls. This prevents the formation of an excessive amount of fine particles below 5 microns and thereby limits surface area which would otherwise require one to add more total fat in the chocolate for proper flow.

The chocolate of the present invention can be made into a bar, used as a filling or for a coating or it can be molded, as with any other chocolate.

The chocolates of the present invention can be used in a solid bar in which the entire bar is made up of solely chocolate. The solid bar is preferably a geometrical shape, for example, a circle, a rectangle or a square.

The chocolates of the present invention can additionally be used as a coating. As used herein, the term “coating” refers to a chocolate composition that covers or envelops a food. Various foods which maybe coated include fruits (e.g. cherries, strawberries, bananas and the like), marshmallow, cake, cookies, toffee, peanut butter, caramel, nuts, raisins, nougat, baked goods, ice cream bars, candy bars, puddings, creams, and the like. Consequently, as used herein, a solid bar with inclusions is a type of coating.

Apart from being used in a solid bar and as a coating, the chocolates of the present invention can also be used in making novelty shapes as previously defined.

Further the standardized and non-standardized chocolates prepared in the instant embodiment can be used in edible food compositions such as confectioneries, chocolate chips, baking chocolate, chocolate covered fruits, chocolate covered baked goods, chocolate covered puddings, and the like. The chocolate of this embodiment can be used in a direct one to one substitution in edible food formulations wherever traditional chocolates are utilized.

The chocolate composition in accordance with the present invention may comprise an intermediate chocolate composition that has not yet been finally processed into a final chocolate product. In an alternative, the chocolate composition may alternatively comprise a final chocolate composition that is intended to be used, or consumed, in the form of a final chocolate product.

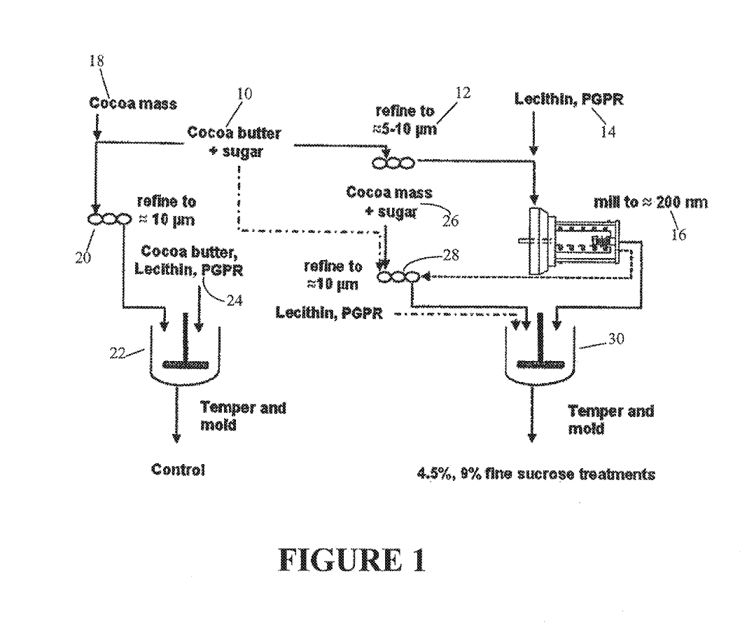

The chocolate composition of the present invention is prepared by techniques known in the chocolate art. An exemplary process is illustrated in FIG. 1. A desired amount of the nutritive carbohydrate sweetener, such as sucrose, in the weight percentage described hereinabove is reduced in size to the nanometer range. In an embodiment, it may be reduced more than once, to an intermediate size, for example, 5 to 10 J·tm and then further reduced in a second step or third step to the nanometer range. In an another embodiment, the desired percentage of nutritive carbohydrate sweetener is reduced to a smaller size, such as 5 to 10 J·tm and then in a second mill is reduced to the nanometer size. The nanometer sized particles are then mixed with additional nutritive carbohydrate sweetener, cocoa butter or chocolate liquor and emulsifier and dependent on the type of chocolate prepared, the other ingredients found in that type of chocolate. For example, if it is a milk chocolate, milkfat, would additionally be present. These other components are mixed and refined, in accordance with the preparation of conventional chocolate. The nanometer size components are then thoroughly mixed with these other components in the chocolate composition and then tempered, in accordance with the procedures for making conventional chocolates.

The present process does not require a conching step normally found in the preparation of traditional chocolate, although conching may be utilized.

As used herein, the term “or” includes the conjunctive and the disjunctive.

Further, the singular denotes the plural and vice versa. In addition, unless designated to the contrary, % in a composition refers to percent by weight.

Further, the term “nanosized”, as used herein, as it relates to chocolates, particles or materials, or other compositions, refers to the chocolates, particles or materials or other compositions having solid particles, such as the nutritive carbohydrate sweetener, having particles in the size in the nanometer range, e.g., such as about 50 to about 1000 nanometers.

The term “nanoparticles”, as used herein, are nanosized particles, as defined herein.

Moreover, as used herein, the term “nanometer range” and “nanometer size range” and “nanosized” are all synonymous and refer to a size of about 50 nanometer up to about 1000 nanometers.

The term “non-fat dairy solids” is used herein as in the confectionery arts. It includes such components as non-fat milk solids, non-fat buttermilk solids, non-fat cream solids, nonfat milk powder, whey powder, whey protein concentrates, whey protein isolates, and the like.

The following non-limiting examples further illustrate present invention.

### EXAMPLES

### Example 1

In accordance with FIG. 1, a suspension of cocoa butter and sugar 10 (ca. 75% w/w sugar) was prepared and milled using a roller mill to produce a median particle size of about 10 microns 12. A portion of the milled suspension was then diluted with cocoa butter and 3.5% lecithin and 3.5% w/w PGPR 14 to a final concentration of 30% sucrose and subsequently milled in a media mill (85% charge of 0.3 mm media, 3000 revolutions per minute agitator speed) to a final particle size of 200 nanometers 16.

Three compositions were prepared, all with equal proportions of sucrose, a cocoa butter, cocoa solids non-fat, lecithin, and PGPR. Particular formulas are shown in Table 1, and individual methods of fabrication are also illustrated in FIG. 1. A control composition was prepared which incorporated only conventionally refined sucrose. This composition was prepared by combining the cocoa butter and granular sucrose 10 with cocoa mass 18 in a Hobart mixer and then refining using a 3-roll refiner 20 to a median particle size of about 10 microns. Following refining, the resulting material was transferred to another Hobart mixer 22, and dry conched at 70 degrees centigrade for 30 minutes, at which point the lecithin, PGPR and balance of cocoa butter 24 were added, and the mixture was wet couched for an additional 1.5 hr at 70 degrees centigrade to ensure homogeneity. Compositions containing 4.5 and 9.0 percent (w/w) of fine sucrose were prepared in a similar fashion (i.e., using additional cocoa mass and sugar 26, an additional refiner 28 and an additional Hobart mixer 30), except that a milled suspension of sucrose, cocoa butter, lecithin and PGPR 16 was prepared as described above and used to deliver the appropriate amount of fine sucrose.

TABLE 1

| Ingredient | Control | Low Susp. | High Susp. |
|---|---|---|---|
| Chocolate liquor | 30.00 | 30.00 | 30.00 |
| Cocoa Butter | 13.85 | 13.85 | 13.85 |
| Sucrose Refined | 54.98 | 50.49 | 46.00 |
| Sucrose Milled | | 04.49 | 08.98 |
| Lecithin | 00.47 | 00.47 | 00.47 |
| PGPR | 00.70 | 00.70 | 00.70 |

All three compositions were tempered and molded into cylinders 12 mm in diameter and 10 mm high. Demolded samples were stored at room temperature in sealed plastic containers until analyzed.

The thermal stability of the foregoing molded chocolates was measured using a Dynamic Mechanical Analyzer (model Q800, TA Instruments, New Castle, Del., USA or model DMA 7e, Perkin Elmer, Norwalk, Conn., USA) equipped with a parallel plate geometry and temperature control mantle. A cylinder of tempered and molded chocolate composition was placed in the measurement geometry and equilibrated at the starting test temperature for 15 minutes. For temperature sweeps, a constant normal force of 0.15 N was applied to the chocolate sample and the temperature was increased from 20° C. to 50° C. at a rate of 2.5° C./minute. For stress scans, the samples were equilibrated at 40° C. and oscillation normal force was increased from 0.01 N to 1 Nat a rate of 0.25 N/minute and an oscillation frequency of 1 Hz.

The probe position (i.e., the difference in millimeters between the top and bottom plates in the measurement geometry) was recorded throughout each test, and data were recorded as a percentage change in probe position as either a function of temperature or applied force F calculated as follows

ΔPP(T)=((PP_{T}−PP_{O})/PP_{O})×100

ΔPP(F)=((PP_{F}−PP_{O})/PP_{O})×100

Where PP_{T} and PP_{F} represent the probe position at the characteristic time and characteristic normal force, respectively, and PP_{O} is the probe position at the beginning of the test. A value of ΔPP of −100% therefore correlates with a complete collapse of a sample.

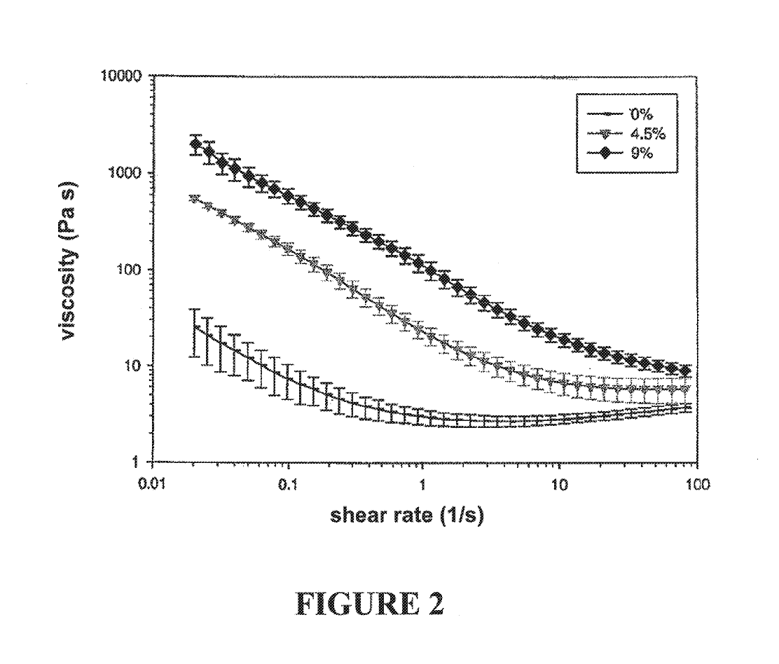

As is illustrated within FIG. 2, there are dramatic differences in shear viscosity of these samples. The differences decreased as the shear rate approaches 100 l/s, indicating that relatively high shear industrial processes such as mixing, pumping, and deposition may be commercially feasible with such products.

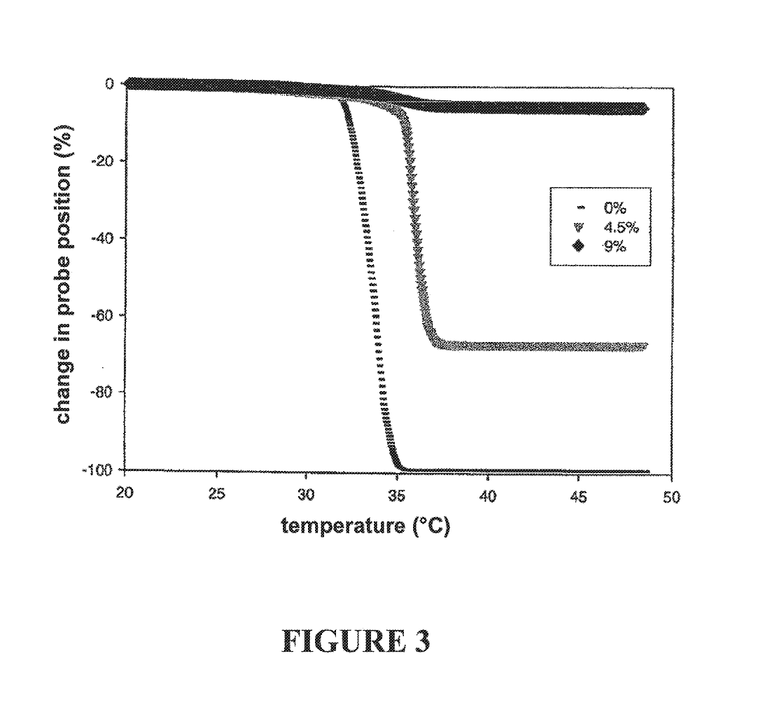

Thermal stability of the test samples was evaluated by subjecting a cylinder of tempered molded sample to a temperature ramp of 20° C. to 48° C. at a ramp rate of 2.5° C./min with a constant normal force of 0.15 N applied. Temperatures above approximately 40° C. will result in all of the lipid continuous phase being present in the liquid phase. The resulting change in DMA probe position as a percentage of initial sample height is plotted against temperature in FIG. 3. The product containing no milled sucrose showed an initial deflection around 33° C., and complete collapse of structure by 35° C. The sample containing 4.5% milled sucrose showed a delayed initial deflection at about 36° C. and only a partial collapse of structure at temperatures up to 48° C. The sample containing 9% milled sucrose showed only approximately a 5% decrease in height across the range of temperatures studied.

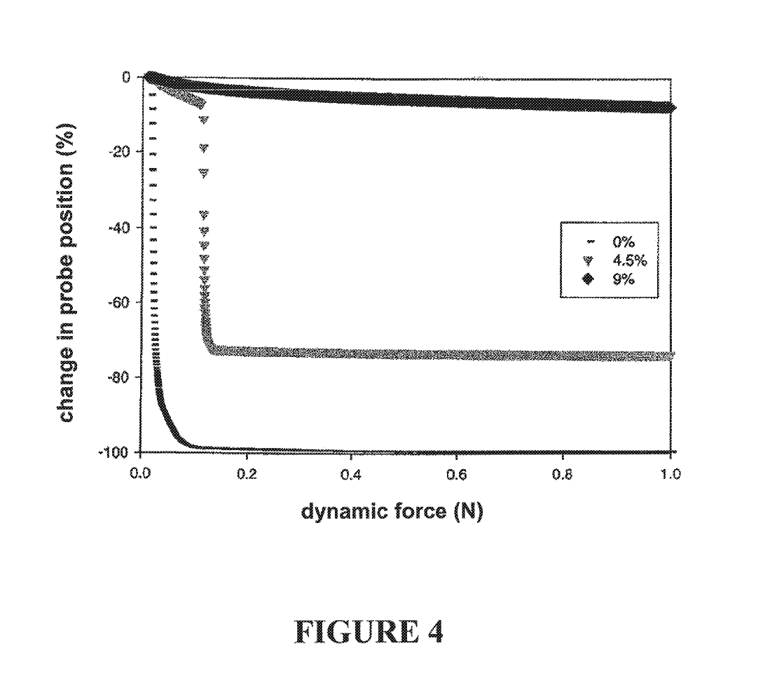

A further experiment was conducted in which samples of the same geometry were maintained at 40° C. and were subjected to a dynamic force ramp from 0.01 N to 1 Nat a ramp rate of 0.025 N/minute and an oscillatory frequency of 1 Hz. Change in probe position as a percentage of initial sample height as a function of dynamic force is plotted in FIG. 4. The sample without milled sucrose shows an almost immediate and complete collapse. The intermediate sample again shows intermediate behavior, with a delayed initial inflection, and only partial collapse under normal forces up to 1 N. The sample with 9% milled sucrose again shows good thermal stability, with less than 10% decrease in sample height over the range of normal forces tested.

The moisture content of all three compositions was 0.63+/−0.01% and the total fat content was 31.8+/−0.03 percent. This indicated that the formulas were very similar in overall composition, and that the pronounced differences observed in rheology and microstructure are most probably due to microstructure differences, but rather to the presence of a secondary structure developed by the presence of the milled sucrose particles.

### Example 2

In accordance with the procedure described in Example 1, a composition containing the following ingredients was prepared.

TABLE 2
Composition of dark chocolate

| | weight percent | |
|---|---|---|
| | | 9% |
| Ingredient | 0% nanosized sucrose | nanosized sucrose |
| Sucrose, nanosized | 0 | 9 |
| Sucrose, conventional size | 54.4 | 45.3 |
| Chocolate liquor | 30 | 30 |
| Cocoa butter | 14.6 | 14.6 |
| Lecithin | 0.7 | 0.7 |
| PGPR | 0.3 | 0.3 |

The probe position was recorded throughout the test and data were recorded as a percentage change in probe position as a function of temperature, as described in Example 1.

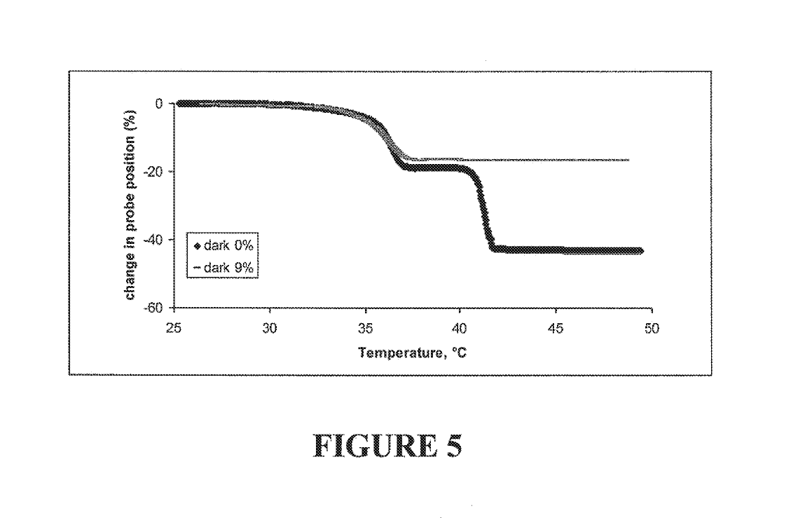

Thermal stability of the test samples was evaluated by subjecting a cylinder of tempered molded sample to a temperature ramp of 20° C. to 48° C. at a ramp rate of 2.5° C./min with a constant normal force of 0.025 N applied. Temperatures above approximately 40° C. will result in all of the lipid continuous phase being present in a liquid state. The resulting change in DMA probe position as a percentage of initial sample height is plotted against temperature in FIG. 5. Both treatments showed an initial reduction in sample height around 35° C. due to irregularities at the surface of the sample. The product containing no nanosized sucrose showed a pronounced collapse of structure by 35° C., while the sample containing 9% nanosized sucrose showed only a small decrease in height across the range of temperatures studied.

### Example 3

The above procedure of Example 2 was repeated, except that the chocolate used was either milk chocolate or compound chocolate, containing the ingredients in Tables 3 and 4, respectively.

TABLE 3
Composition of milk chocolate

| | weight percent | |
|---|---|---|
| | | 9% |
| Ingredient | 0% nanosized sucrose | nanosized sucrose |
| Sucrose, nanosized | 0 | 9 |
| Sucrose, conventional size | 48.4 | 39.4 |
| Chocolate liquor | 12 | 12 |
| Cocoa butter | 20.6 | 20.6 |
| NFDM | 15 | 15 |
| AMF | 3 | 3 |
| Lecithin | 0.7 | 0.7 |
| PGPR | 0.3 | 0.3 |

TABLE 4
Composition of compound chocolate

| | weight percent | |
|---|---|---|
| | | 9% |
| Ingredient | 0% nanosized sucrose | nanosized sucrose |
| Sucrose, nanosized | 0 | 9 |
| Sucrose, conventional size | 51.4 | 42.4 |
| Chocolate butter substitute | 30.6 | 30.6 |
| NFDM | 10 | 10 |
| Cocoa powder | 7 | 7 |
| Lecithin | 0.7 | 0.7 |
| PGPR | 0.3 | 0.3 |

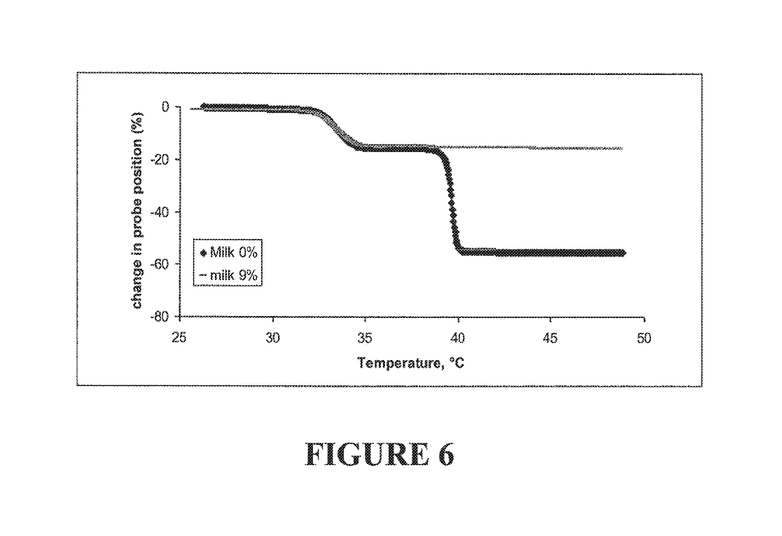

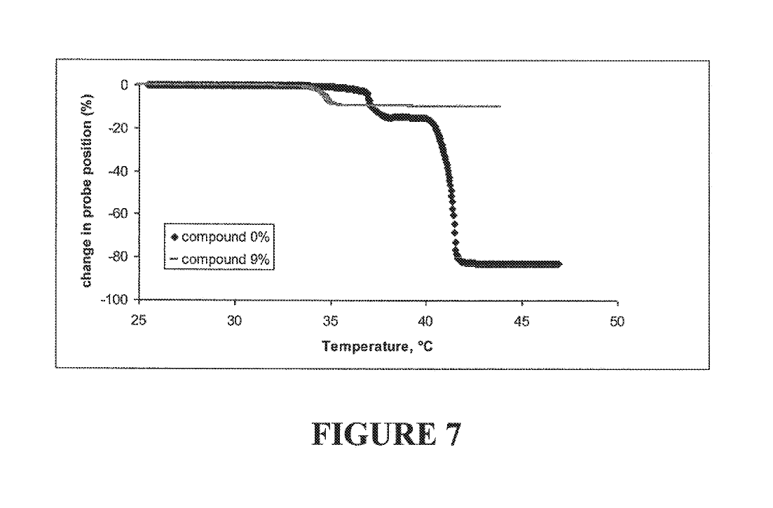

The thermal stability of the chocolate samples is depicted in FIGS. 6 and 7, respectively.

The preferred embodiments and examples of the invention are illustrative of the invention rather than limiting of the invention. Revisions and modification may be made to methods, materials, and components of a chocolate composition and a method for manufacturing the chocolate composition in accordance with invention, further in accordance with the accompanying claims.

1. In an improved chocolate composition comprising a nutritive carbohydrate sweetener, an emulsifier and cocoa butter, the improvement comprising the nutritive carbohydrate sweetener ranging in size from about 50 to about 1000 nm, said portion being sufficient to prevent chocolate from melting at body temperature or below.

2-23. (canceled)

24. A method for manufacturing an improved chocolate composition comprising refining a nutritive carbohydrate sweetener, to produce a first product having an average particle size ranging in size from about 50 to about 1000 nm, and mixing said first product with a mixture comprising additional nutritive carbohydrate sweetener, cocoa butter, and emulsifier to form a chocolate composition and then mixing with a milled composition comprising chocolate liquor and/or a cocoa butter, additional nutritive carbohydrate sweetener, additional emulsifier and optionally one or more ingredients selected from the group consisting of milk fat, non-fat dairy solids, non-fat cocoa solids, buttermilk and mixtures thereof at a temperature sufficiently heated enough to maintain the resulting mixture as a liquid for sufficient time to be thoroughly and evenly mixed and then tempering the resulting mixture.

25. The method of claim 24 wherein the nanosized nutritive carbohydrate sweetener is present in amount ranging from about 1 to 40 wt % of the chocolate composition.

26. The method of claim 24 wherein the nanosized nutritive carbohydrate sweetener is sucrose.

27. The method of claim 24 wherein filler is additionally present.

28. The method according to claim 24 wherein the size of the nutritive carbohydrate sweetener in the first product ranges from about 75 to about 500 nm.

29. The method according to claim 28 wherein the size of the nutritive carbohydrate sweetener in the first product ranges from about 100 to about 300 nm.

30. The method according to claim 29 wherein the size of the nutritive carbohydrate sweetener in the first product is about 200 nm.

31. The method according to claim 30 additionally comprising a component consisting of non-fat dairy solids or non-fat cocoa solids and a mixture thereof, said components being comprised of particles ranging from about 50 to 1000 nm.

32. The method according to claim 31 wherein the average size of the particles in the component ranges from about 75 to about 500 nm.

33. The method according to claim 32 wherein the averages size of the particles in said component ranging from about 100 to about 300 nm.

34. The method according to claim 33 wherein the average size of the particles in said component being about 200 nm.

35. The method according to claim 1 which additionally comprises bulking agents.

36. The method according to claim 35 wherein said bulking agent has particles ranging in size from about 50 to about 1000 nm.

37. The method according to claim 36 wherein said bulking agent has particles ranging in size from about 75 to about 500 nm.

38. The method according to claim 37 wherein said bulking agent has particles ranging in size from about 100 to about 300 nm.

39. The method according to claim 38 wherein said bulking agent has particles of about 200 nm in size.
